(19) United States
(12) Patent Application Publication
(10) Pub. No.: US 2013/0218606 A1
(43) Pub. Date: Aug. 22, 2013

(54) SYSTEM, METHOD, AND COMPUTER-READABLE MEDIUM FOR DETERMINING AN INSURANCE RATING CLASS

(71) Applicant: Paul Klimek, Boca Raton, FL (US)

(72) Inventor: Paul Klimek, Boca Raton, FL (US)

(73) Assignee: APPTICAL CORP., Boca Raton, FL (US)

(21) Appl. No.: 13/589,972

(22) Filed: Aug. 20, 2012

Related U.S. Application Data
(60) Provisional application No. 61/525,288, filed on Aug. 19, 2011.

(51) Int. Cl. G06Q 40/08

(52) U.S. Cl. CPC G06Q 40/08
USPC 705/4

(57) ABSTRACT

A system, method, and non-transitory computer readable medium for enabling the evaluation of insurance application data. More particularly, the present disclosed subject matter pertains to a mechanism enabled to obtain application data regarding an individual seeking insurance, to evaluate the application data in regard to one or more product rules, and to assign a rating class for the individual accordingly. The individual is assigned the optimum rating class and this rating class is lowered, as necessary, based upon whether the application meets one or more of the product rule conditions. Additionally, the disclosed subject matter provides for a rule authoring interface which permits product rules to be created via natural-language input.

### CROSS-REFERENCE

The present application claims benefit to U.S. Provisional Patent Application No. 61/525,288, which was filed on Aug. 19, 2011, the contents of which are incorporated by reference in their entirety as if recited in full herein.

### FIELD

The disclosed subject matter generally pertains to evaluating data obtained for an insurance application. More particularly, the disclosed subject pertains to systems, methods, and computer-readable medium for evaluating insurance application data in order to determine an individual's eligibility for an insurance product.

### BACKGROUND

When an individual applies for an insurance product, such as life insurance, an insurance underwriting company gathers information regarding the individual and evaluates this information. Underwriting involves evaluating an individual seeking insurance (herein referred to as a “proposed insured”) and classifying the risk the individual represents for the insurance company or the insurance company affiliate offering the product (herein referred to as a “client company”). Factors such as the proposed insured's physical health, medical history, occupation, avocations, prescription history and more are analyzed.

The evaluation process may involve an analysis of data provided by the proposed insured, from an insurance agent, and/or another individual (such as a legal guardian). The underwriter company may also collect data about the proposed insured from one or more third-party sources. For example, the underwriter company may obtain Medical Information Bureau (MIB) data.

An underwriter may manually evaluate a proposed insured's application data by referencing an underwriting manual. An underwriting manual is a document that provides background information about various underwriting impairments and suggests the appropriate action to take if such impairments exist. Based upon this evaluation, the underwriter assigns the proposed insured a rating class. The rating class indicates a proposed insured's risk level and, in turn, whether the proposed insured qualifies for the sought after insurance product and the cost of the insurance premium. For example, rating class categories may be: Preferred (discounted premium), Standard (standard premium), Rated (higher premium), or Declined (declined coverage). Manually underwriting is a slow, inefficient process and is prone to human error.

Modern underwriting companies employ automated rules engines to evaluate application data. These rules engines are designed to ease the application process by enabling quick determination of a proposed insured's eligibility. Underwriting rules engines evaluate application data by comparing it against criteria associated with the sought after insurance product, with each criterion having a different value. Different elements are weighed more heavily than others to reflect their importance to the final score and the score value assigned for each particular criterion is a credit or debit value. For example, being a smoker may be worth a −50 debit, whereas not being on any prescription medicine may be worth a +30 credit. Substantially negative application data is counter-balanced, or even exceeded, by substantially positive application data, and vice versa. Once the rules engine has completed its evaluation, it determines a final score based upon the sum of the credits and debits. The final score is compared against score ranges assigned to each rating class and the proposed insured is assigned the corresponding rating class. For example, if the final score is 701 and the Preferred rating class score range is 700-800, the proposed insured is assigned the Preferred rating class.

Evaluating application data in this manner is problematic because it does not provide an accurate portrayal of the proposed insured's risk. The various criteria employed during evaluation, while all related to the proposed insured, are not inherently related to one another. For example, a proposed insured's score may receive a credit if he is a non-smoker, but may receive a debit if he has a high-risk occupation. Although these two characteristics of the proposed insured have no direct relation to one another, they, in effect, do so in a credit/debit-based system. Such systems rely on the final score for determining an individual's rating class, rather than individual characteristics of the proposed insured.

Furthermore, these rules engine systems do not account for the particular requirements of a client company's insurance product. The underwriting company must assign a credit or debit value to each criterion provided by the client company. This can be cumbersome and as such rules engines are typically hardcoded, it often requires custom programming for any special rule or requirement. The client company must instruct the underwriter about its requirements and review the evaluations generated by the rules engine to ensure that they are accurate.

What is lacking is a system that automatically enables an accurate evaluation of application data based upon actual characteristics of a proposed insured rather than values assigned to such characteristic criteria. Furthermore, what is needed is a system that may be conveniently configured for one or more specific requirements of a multitude of insurance products.

### SUMMARY

Systems, methods, apparatuses, and non-transitory computer-readable medium are provided that enable the evaluation of insurance application data. More particularly, the disclosed subject matter pertains to obtaining application data regarding a proposed insured, evaluating the application data in regard to one or more product rules, and assigning a rating class for the proposed insured for underwriting and application approval purposes. In certain embodiments, during the evaluation, a proposed insured may be assigned the optimum rating class and this rating class may be lowered, as necessary, based upon whether the application meets one or more of product rule criteria. Additionally, the disclosed subject matter provides for a rule authoring interface which permits product rules to be created via natural-language input.

An object of the disclosed subject matter is to provide a system that evaluates application data on-demand and in a product-centric and/or rating class-centric fashion.

An additional object of the disclosed subject matter is to provide a system that determines a rating class for a proposed insured by lowering the rating class each time a rule criterion is met.

Yet another object of the disclosed subject matter is to provide a system that enables authoring, testing, deployment, and management of business and underwriting rules.

An additional object of the disclosed subject matter is to provide a system that may evaluate data regarding a proposed insured from one or more sources, including third-party systems.

A further object of the disclosed subject matter is to provide a system that includes an interface for product rule authoring that includes a natural-language vocabulary to allow for the simple authoring of complex industry specific rules.

Yet another object of the disclosed subject matter is to enable one or more users to configure a product rule.

An additional object of the disclosed subject matter is to enable the configuration of a product rule that ensures that application data is obtained per industry and/or regulatory requirements.

These and other aspects of the disclosed subject matter, as well as additional novel features, will be apparent from the description provided herein. The intent of this summary is not to be a comprehensive description of the to be claimed subject matter, but rather to provide a short overview of some of the subject matter's functionality. Other systems, methods, apparatuses, computer-readable medium, features, and advantages here provided will become apparent to one with skill in the art upon examination of the following FIGUREs and detailed description. It is intended that all such additional systems, methods, apparatuses, computer-readable medium, features, and advantages that are included within this description, be within the scope of any claims filed later.

### BRIEF DESCRIPTION OF THE DRAWINGS

In order to describe the manner in which the above-recited and other advantages and features of the disclosed subject matter may be obtained, a more particular description will be rendered by reference to specific embodiments thereof that are illustrated in the appended drawings. Understanding that these drawings depict only typical embodiments of the disclosed subject matter and are not therefore to be considered limiting of its scope, the disclosed subject matter will be described and explained with additional specificity and detail through the use of the accompanying drawings in which:

FIG. 1 depicts a component architecture of an application data evaluation network according to an exemplary embodiment;

FIG. 2 depicts an architecture overview of an underwriting rules engine system according to an exemplary embodiment;

FIG. 3 depicts a process for configuring a product record so that it may be employed to evaluate application data to determine a rating class for a proposed insured according to an exemplary embodiment; and

FIG. 4 depicts a flowchart of a process of evaluating application data to determine a rating class for a proposed insured according to an exemplary embodiment.

### DESCRIPTION

Various embodiments of the disclosed subject matter are discussed in detail below. While specific implementations are discussed, this is done for illustration purposes only. A person of ordinary skill in the relevant art will recognize that other components and configurations may be used without departing from the spirit and scope of the disclosed subject matter.

The disclosed subject matter described here is typically described in relation to life insurance; however this is not to be construed as limiting. The systems and methods presented herein may also be applicable to other scenarios, such as other types of insurance (e.g., health insurance, automobile insurance, home insurance, etc.) or any situation in which application data is received and analyzed in order to determine a rating, ranking, score, etc.

### Application Data Evaluation Network

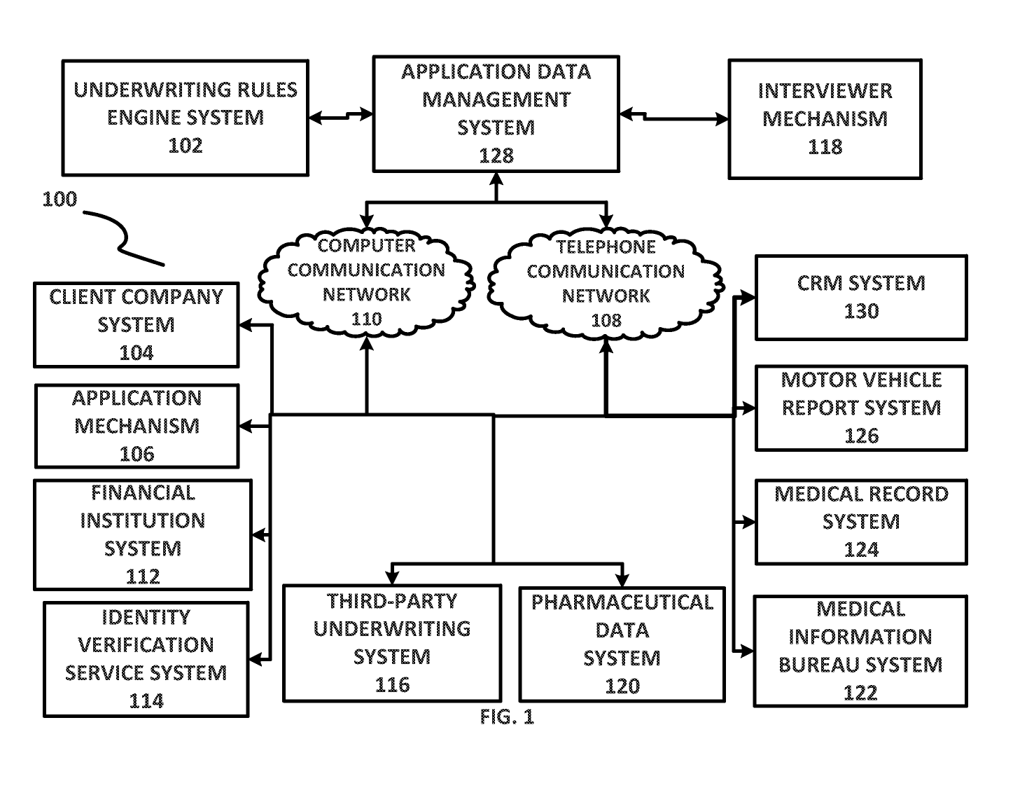

FIG. 1 depicts a component architecture of an application data evaluation network 100 according to an exemplary embodiment. Application data evaluation network 100 may include one or more components to enable evaluation processes, such as underwriting rules engine system (URES) 102, client company system 104, application mechanism 106, financial institution system 112, identity verification service system 114, third-party underwriting system 116, interviewer mechanism 118, pharmaceutical data system 120, MIB system 122, medical record system 124, motor vehicle record (MVR) system 126, application data management system 128, and customer relationship management (CRM) system 130.

Those with ordinary skill in the art will recognize that the components set forth in FIG. 1 are merely exemplary and that other configurations that provide substantially similar functionality to that of the components in FIG. 1 may be used consistent with the scope of the disclosed subject matter. Although only a single instance of each component is depicted, this is for illustrative purposes only and is not to be construed as limiting. For example, application data evaluation network 100 may include multiple client company systems 104, application mechanisms 106, financial institution system systems 112, identity verification service system systems 114, third-party underwriting systems 116, interview mechanisms 118, pharmaceutical data systems 120, MIB systems 122, medical record systems 124, MVR systems 126, application data management systems 128, and CRM systems 130. Additionally, it is to be understood that proposed insured and/or insurance agents may employ one or more application mechanisms 106 and/or interviewers may employ one or more interviewer mechanisms 118. Although each component is depicted and described as separate, this is not to be construed as limiting, and components may be combined per implementation. For example, URES 102 may be a component of application data management system 128.

It is to be understood that the components depicted may be logical components and that the terminology used herein to describe each component is for illustrative purposes and is not to be construed as limiting. Each component may include the necessary apparatuses, hardware, firmware, and/or software to enable the processing, storing, communicating and/or receiving of data. A component may include one or more computer processors, computer servers, data stores, electronic components, storage mediums, memory, etc. The functionality of a component may be directed by one or more executable computer-readable instructions received via a computer-readable storage medium. A processor may be included to execute one or more functions per instructions, programs, or processes stored in the processor itself and/or stored in another memory source. Memory may be any mechanism that is capable of storing data, such as computer programs, instructions, and other necessary data. One or more interfaces may be included to enable the presentation, manipulation, transmission, and receipt of data. Communication of data may be enabled by one or more networks or physical connections. A network may include one or more of a wide-area network (WAN) (such as the Internet), a local area network (LAN), a wireless local area network (WLAN), a personal area network (PAN), a wireless personal network (WPAN), a mobile wireless network, a telephone network, a combination of any of the aforementioned, or any other suitable network and may include any component (physical or logical) necessary for a particular network's functionality, such as routers, adapters, subnets, etc.

In certain embodiments, one or more of the components may communicate via telephone communication network 108 and/or computer communication network 110. Telephone communication network 108 may be any applicable telephony network capable of relaying telephone-based communications, such as a plain old telephone service (POTS) network, a mobile telephony network, integrated services digital network (ISDN), etc. Furthermore, telephone communication network 108 may enable text-based messaging, such as short message service (SMS) text messaging. Computer communication network 110 may be any applicable electronic network capable of relaying voice or data messages, such as the Internet or a mobile data network. For example, computer communication network 110 may enable Voice over Internet Protocol (VoIP) communication, email communication, instant messaging, World Wide Web functionality, etc. For example, computer communication network 110 may include one or more of a LAN, a PAN, a WLAN, a WAN, a WPAN, etc.

Application data management system 128 may be enabled to receive and communicate data associated with an insurance application, such as product data and application data. Application data may include disclosure data and/or third-party source data. Disclosure data may be any data associated with a proposed insured that has been obtained from the proposed insured directly or from the proposed insured by an insurance agent, interviewer, legal guardian of the proposed insured, etc. Disclosure data may include information provided by a proposed insured in response to the requirements of a product questionnaire, application, etc. For example, disclosure data may pertain to the proposed insured's contact information, medical history, prescription history, family history, physical characteristics, financial information, etc. Third-party source data may be any data associated with the proposed insured that has been obtained from a third-party source. Product data may include data relevant to one or more insurance products offered by a client company, including information regarding rating classes, product rule data, premiums, etc. Application data management system 128 may be configured to obtain application data from interviewer mechanism 118, application mechanism 106, and/or one or more third-party data sources, and may communicate application data to URES 102. In certain embodiments, application data management system 128 may be maintained by an underwriting service provider.

URES 102 may be enabled to receive application data and evaluate it based upon product rule data. As detailed below, URES 102 may evaluate application data by determining whether one or more elements of application data meet a rule criterion.

Client company system 104 may include a client company's application system and may be configured to communicate product data, receive application data, and/or receive rating class evaluation data. Product data may include data regarding the rating classes for a particular insurance product, such as rating class categories, the optimum rating class for a proposed insured, product rule data, etc. Product data may include information that details one or more stipulations for obtaining an insurance product. Product rule data may detail one or more criteria that, if met, may lower a proposed insured's rating class, thereby affecting the associated premium and/or the proposed insured's eligibility to obtain the associated insurance product. For example, a product rule may stipulate that the presence of a particular medical condition in the proposed insured's medical history or that of his/her family warrants a rating class reduction.

Application mechanism 106 may be any appropriate mechanism that enables a proposed insured, insurance agent, and/or authorized individual to provide disclosure data. Application mechanism 106 may be a standard telephone, a mobile device (e.g., a mobile phone or a smartphone), a personal computer (e.g., a desktop computer, a laptop computer, a tablet computer, etc.), or any other suitable device. Application mechanism 106 may be configured to communicate via computer communication network 110 and/or telephone communication network 108, as would be appropriate per the particulars of the application mechanism 106 employed. For example, a proposed insured and/or insurance agent may use a telephone to provide disclosure data via telephone communication network 108 or may use a personal computer to provide disclosure data via computer communication network 110.

Interviewer mechanism 118 may be any appropriate mechanism that is configured to present an interviewer interface to an interviewer. An interviewer may be an individual responsible for obtaining disclosure data through various means, such as by interviewing a proposed insured, an insurance agent, etc. For example, an interviewer may be an employee of an underwriting service provider. Interviewer mechanism 118 may be, for example, a personal computer, a mobile device, telephone, etc. Interviewer mechanism 118 may communicate directly with application data management system 128, as shown in FIG. 1. In an alternative embodiment, interview mechanism 118 may be configured to communicate with application data management system 128 via computer communication network 110 and/or telephone communication network 108.

In addition to evaluating disclosure data, URES 102 may evaluate data from one or more third-party sources. A third-party data source may be one or more third-party data source systems, such as financial institution system 112, identity verification service system 114, third-party underwriting system 116, pharmaceutical data system 120, MIB system 122, medical record system 124, MVR system 126, and CRM system 130. A third-party data source system may aggregate data from multiple sources. If application data management system 128 has access to third-party interviewers, interviewer mechanism 118 may be considered a third-party data source.

Financial institution system 112 may be a system managed by a credit rating agency, a bank, a credit card issuer, or any other suitable party. Data from financial institution system 112 may be used, for example, in order to determine a proposed insured's financial standing (e.g., to obtain credit score and/or credit report data), to determine whether the proposed insured has a valid checking account, etc.

Identity verification service system 114 may be a system managed by a background check service, a government agency, or any other suitable party. Identity verification service system 114 may provide data regarding the validity of a proposed insured's purported identity, such as by providing data that may or may not correspond with disclosed identity information that the proposed insured has disclosed.

Third-party underwriting system 116 may be a system managed by a third-party underwriting service provider or other suitable party, such as a service that evaluates application data received by application data management system 128 and/or other sources in order to determine a rating, ranking, score, or other evaluation that is indicative of a proposed insured's qualifications for a product. For example, third-party underwriting system 116 may include a third-party underwriting rules engine system, such the one operated by Merica-US® (a registered trademark of Hannover Life Reassurance Company of America).

Pharmaceutical data system 120 may be a system that maintains prescription history data and other pharmaceutical data for one or more individuals. In certain embodiments, pharmaceutical data system 120 may be a system managed by an administrator of one or more prescription drug programs, such as a Pharmacy Benefit Manager or other suitable party. Pharmaceutical data system 120 may provide data indicative of which medicines a proposed insured takes or has taken, prescription frequency, prescription quantities, etc.

MIB system 122 may be a system managed by the MIB. The MIB collects information about individuals who have applied for insurance (or had someone apply on their behalf). Information received from MIB system 122 may be used to determine if a proposed insured has applied for insurance before and, if so, if the previously provided information corresponds with the presently provided information.

Medical record system 124 may be a system that stores information about the medical history of individuals. For example, medical record system 124 may be a system managed by a healthcare provider or other suitable party. Information obtained from medical record system 124 may be compared to data regarding a proposed insured and/or used in place of requesting it from the proposed insured or other associated individuals.

MVR system 126 may be a system that stores information regarding individuals' use of motor vehicles. For example, MVR system 126 may be a system managed by a government motor vehicle agency (e.g., the Department of Motor Vehicles), an automobile insurance company, or any other suitable party. MVR data may include, for instance, information regarding an individual's citations and other vehicle-based violations, driving history, auto insurance policies, etc.

Application data evaluation network 100 may include CRM system 130, which may be a system managed by a CRM service or other suitable party, such as Salesforce.com® (a registered trademark of Salesforce.com). In certain embodiments, application data management system 128 may interact with CRM system 130 in order to enable and/or enhance the tracking of insurances applications. This may be beneficial for client companies, particularly those that employ the associated CRM service. In one embodiment, CRM system 130 may be used as a source of third-party data regarding a proposed insured.

Although only one instance of each third-party data source system is depicted in FIG.1, as mentioned, this is not to be construed as limiting and application data evaluation network 100 may include multiple instances of one or more of third-party data source systems. Furthermore, although particular third-party data source systems are depicted in FIG. 1, this is not to be construed as limiting and application data evaluation network 100 may include any third-party data source system that may enhance the functionality of application data management system 128 and/or URES 102.

### Underwriting Rules Engine System

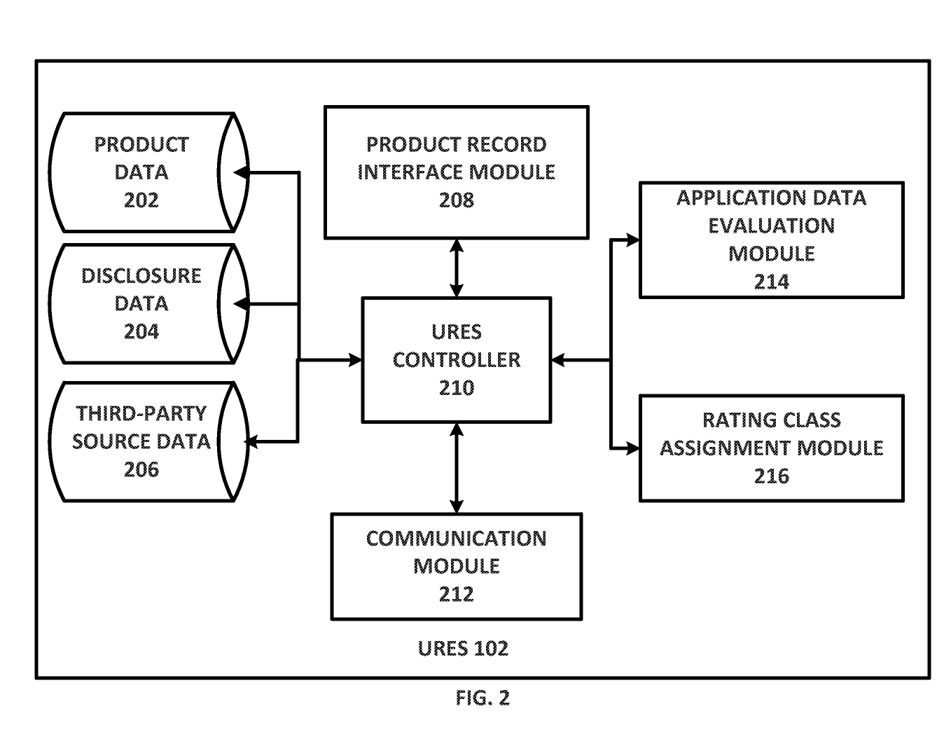

FIG. 2 depicts an architecture overview of URES 102 according to an exemplary embodiment. Those with ordinary skill in the art will recognize that the components set forth in FIG. 2 are merely exemplary and that other configurations that provide substantially similar functionality to that of the components in FIG. 2 may be used consistent with the scope of the disclosed subject matter. Although only a single instance of each component is depicted, this is for illustrative purposes only and is not to be construed as limiting. Furthermore, although each component is depicted and described as separate, this is not to be construed as limiting, and components may be combined per implementation.

URES 102 may be configured to analyze application data to determine a rating class for a product for a proposed insured. The rating class may be used to calculate the rate that the proposed insured may be required to pay to a client company for insurance coverage and/or to determine the proposed insured's eligibility for one or more insurance products. URES 102 may also enable a business user to configure one or more product rules that may be used to evaluate a proposed insured's risk level for an insurance product.

In one embodiment, URES 102 may be a Web service created and run, for example, via the Microsoft® (a registered trademark of Microsoft Corp.) Platform and hosted on Windows® (a registered trademark of Microsoft Corp.) Azure. Administration features may be enabled via an application framework, such as Microsoft Silverlight® (a registered trademark of Microsoft Corp.). Any external system with the credentials may be enabled to interact with URES 102. For example, an external system may be authorized based upon credentials associated with the proposed insured, an interviewer, or a client company, a product identifier identifying an insurance product, etc.

URES 102 may include URES controller 210, which may be configured to route data between one or more URES 102 components. Communication module 212 may manage the receipt and transmission of data between URES 102 and other application data evaluation network 100 components. In one embodiment, communication module 212 may interact with application data management system 128 in order to interact with other application data evaluation network 100 components, such as to obtain product data, disclosure data, and/or third-party source data. In another embodiment, communication module 212 may allow URES 102 to communicate with one or more components of application evaluation data network 100 directly.

URES 102 may store data that is necessary for application data processing, such as product data 202, disclosure data 204, third-party source data 206, etc. Such data may be maintained in one or more data stores and may be obtained from application data management system 128 and/or directly from one or more components of application evaluation data network 100. Application data management system 128 may share disclosure data and third-party source data with URES 102 so that it may evaluate it per product rule data. For example, via a user interface of interviewer mechanism 118, an interviewer may input disclosure data obtained from a proposed insured and the disclosure data may be stored in application data management system 128. Application data management system 128 may obtain third-party source data associated with the proposed insured individual from one or more third-party source systems. URES 102 may store product data 202, disclosure data 204, and/or third-party source data 206 temporarily or long-term, as necessary. For example, URES 102 may store product data 202 associated with a plurality of products until such data is removed per administrator instruction, but may store disclosure data 204 and third-party source data 206 only until it has assigned the associated proposed insured a rating class. In one embodiment, URES 102 may not store product data, disclosure data, and/or third-party source data, but rather may access such data from data stores maintained by application data management system 128 and/or another system.

Product record interface module 208 may enable one or more business users to interact with URES 102. Product record interface module 208 may enable natural-language rule authoring of one or more product records for one or more insurance products. A business user may be any entity (e.g., an individual or an organization) that may have a business reason to interact with URES 102. For example, a business user may be an underwriting service provider employee, a client company representative, a medical director, an actuary, a third-party underwriter, etc. As described below, product record interface module 208 may enable a business user to configure one or more product rules to be employed by URES 102 when it evaluates application data associated with a proposed insured to determine the proposed insured's rating class for an insurance product. For example, a client company representative may access URES 102 to provide or adjust criteria for one or more of its insurance products.

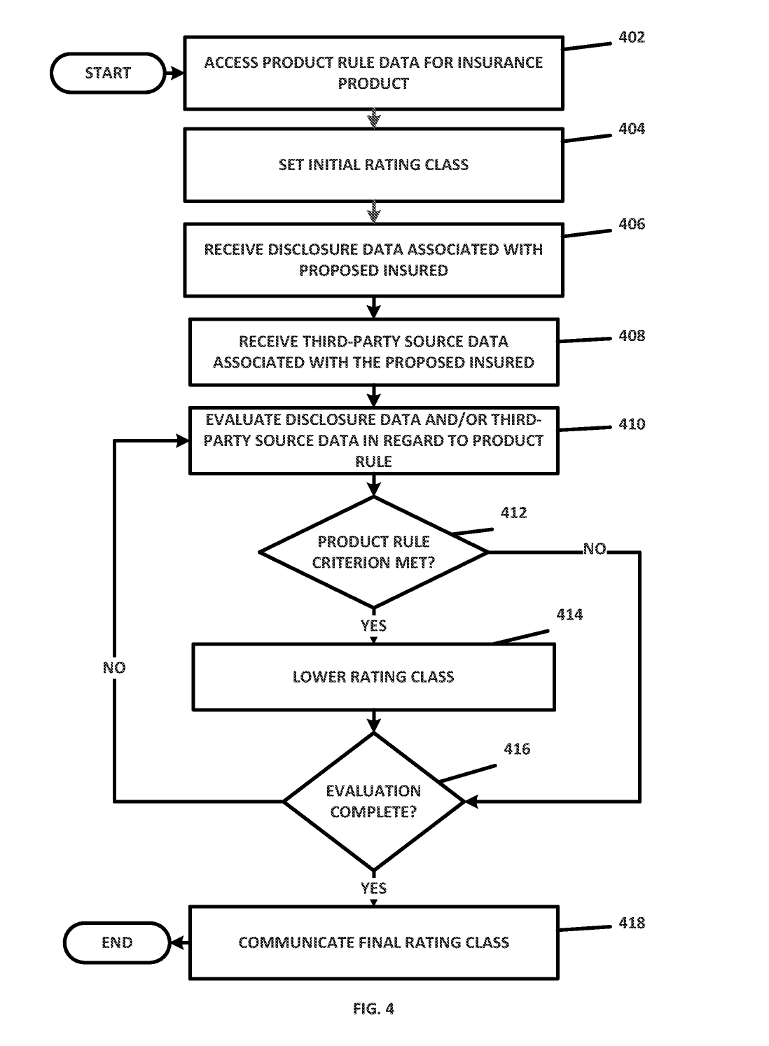

Application data evaluation module 214 may evaluate disclosure data and/or third-party source data for a proposed insured, in terms of one or more product rules for the associated insurance product. An embodiment of an evaluation process is discussed in relation to FIG. 4 below.

Rating class assignment module 216 may assign a rating class based upon an evaluation of a proposed insured's application data. Rating class assignment module 216 may lower a proposed insured's rating class whenever a product rule criterion for the desired product is met. The assigned rating class may be communicated to one or more relevant parties (e.g., the proposed insured, the insurance agent, the client company, etc.) by communicating it to application data management system 128 and/or to another application data evaluation network 100 component (e.g., client company system 104, application mechanism 106, interviewer mechanism 118, etc.). In addition to a rating class itself, rating class assignment module 216 may provide data regarding why a rating class was assigned, such as information regarding which product rules where applied, which product rules were met and/or were not, etc.

### Product Record Configuration

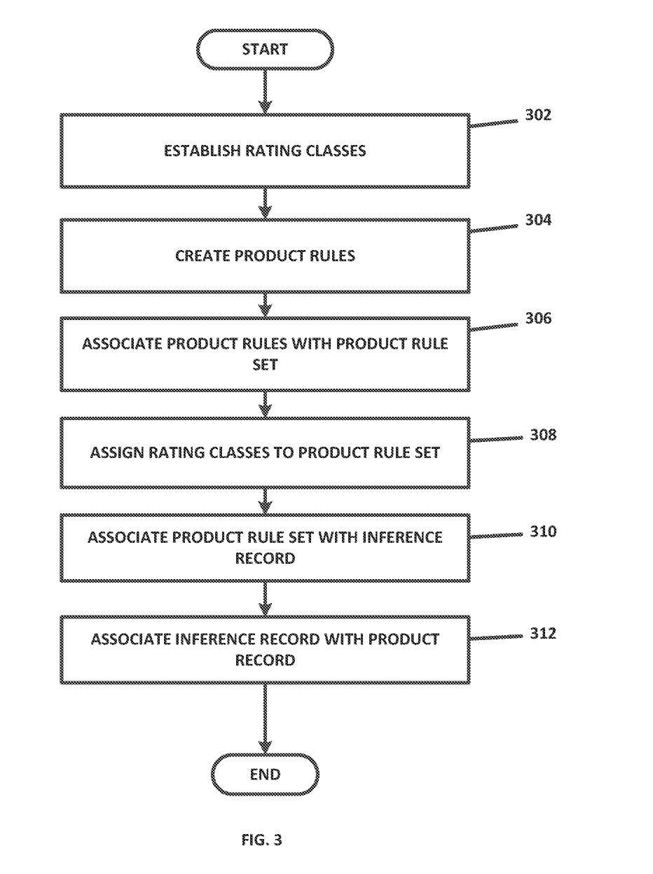

FIG. 3 depicts a process for configuring a product record so that it may be employed to evaluate application data to determine a rating class for a proposed insured according to an exemplary embodiment. In one embodiment, product record configuration is enabled via product record interface module 208. A product record may include data associated with an insurance product, such as data that indicates a client company offering the product, the rating class(es) for the product, and the criteria to be used to determine a rating class for the product, etc. The vocabulary used by the product record interface module 208 may be based upon industry-specific rule types commonly used by third-parties, based upon commonly required application data, etc. As mentioned, product record interface module 208 may enable a user, such as a business user, to interact with URES 102. A user may interact with URES 102 via an appropriate device, such as a personal computer, mobile device, a telephone, etc., in order to configure product rule data. For example, product record interface module 208 may enable a user interface such as a Web browser interface, a traditional software application, a mobile software application (i.e., an “app”), a cloud-based interface, etc. It is to be understood that in the description herein that a user may be employing a mechanism to communicate one or more instructions to URES 102.

URES 102 may establish one or more rating classes to be associated with an insurance product (step 302). As mentioned, a rating class may indicate a proposed insured's risk for an insurance product and may be used to determine the cost of an insurance premium. A user may establish one or more rating classes when a client company initially employs the services of URES 102. As such, rating classes need not be established at every configuration session, but rather may be subsequently updated or added as needed.

One or more product rules may be created for the evaluation of application data for an insurance product (step 304). A product rule may indicate an element of application data to be evaluated and specify one or more criteria by which the element of application data is to be evaluated. Whether a product rule criterion is met may determine whether a rating class is to be lowered. A product rule may pertain to any data included in a proposed insured's application data, such as personal characteristics (e.g., build (e.g., height and weight), age, gender, etc.), pharmaceutical history (e.g., data pertaining to active or previous prescriptions, etc.), third-party source data, and/or any other data that may be required to determine a proposed insured's eligibility for an insurance product. A product rule's criterion may detail how such data is to be evaluated. For example, a product rule may specify that age is to be evaluated based upon whether the proposed insured's age is below, above, or within an age threshold. As another example, a product rule may stipulate that pharmaceutical history data is to be evaluated to determine whether the proposed insured has taken one or more pharmaceuticals.

In one embodiment, two or more product rules may be combined to form a compound product rule. A compound product rule may establish a connection between a set of product rules in order to specify the manner in which the product rules included in the set are used. For example, if a compound rule includes three product rules, application data received for the first product rule and second product rule may be used to determine whether the third product rule is to be applied. A compound rule may enable reflexive questioning, whereby a user may craft the product rules so that further data regarding the proposed insured is acquired based upon the data evaluated by one or more product rules. For example, if a proposed user's age indicates that he is over a specified threshold, he may be required to provide pharmaceutical data and/or third-party source data may be obtained from pharmaceutical system 120. Conversely, if the proposed insured's age indicates that he is under a specified threshold, he may not be required to provide pharmaceutical data or data from pharmaceutical data system 120 may not be accessed.

A product rule may indicate which (if any) third-party data source systems are to be accessed during an evaluation, which elements of third-party source data are to be evaluated, and/or the manner in which third-party source data is to be evaluated. For example, a client company may only wish to involve MIB system 122. Product rules may be configured so that multiple third-party data source systems are accessed serially until a response containing data is received. A third-party data source system provider may charge a fee for providing data to external parties (i.e., the underwriting service provider, the client company, etc.). Product rules may be structured so that the third-party data source systems most relevant to an application are queried first. This may reduce the amount of third-party fees charged. For example, a particular pharmaceutical data system 120 (pharmaceutical data system A) may maintain data for a higher percentage of persons over the age of 50 than another pharmaceutical data system 120 (pharmaceutical data system B). As such, a user may construct a rule that establishes that if the proposed insured is over age 50, query pharmaceutical data system A before querying to pharmaceutical data system B.

Product rules may be configured to enable accurate and regulation-compliant obtainment of application data. For example, third-party source data may indicate that a rule criterion has been met. However, an industry regulation or policy may require that any element of application data that has an adverse effect on the proposed insured (i.e., it lowers the proposed insured's rating class) must be obtained from the proposed insured directly. If such a product rule criterion is met based upon third-party source data, a product rule may be established so that appropriate personnel are notified that the proposed insured needs to be spoken with to obtain disclosure data associated with the met product rule. This configuration may enable the use of third-party source data while also ensuring compliance with industry regulations.

Product rules may be associated with a product rule set, thereby establishing a set of product rules that may be used to evaluate a proposed insured in light of one or more elements of application data (step 306). One or more rating classes may be assigned to the product rule set, thereby establishing which rating class a proposed insured may receive based upon how the application data is interpreted in regard to the product rule set (step 308).

The product rule set may be associated with an inference record (step 310). An inference record may pertain to a category for which the included product rules are applicable. For example, an inference record may be applicable to particular gender, age, or jurisdiction. A jurisdiction may be a region and the included product rule set may allow for compliance with regional regulations. For example, a jurisdiction may be a country, state, county, etc. An inference record may be associated with one or more product rule sets.

An inference record may be associated with a product record, thereby enabling the product record to be used for the evaluation of application data of a proposed insured applying for the associated insurance product (step 312). If a product record for the insurance product does not exist, a new product record may be created. As the evaluation established by an inference record may be applicable to more than one insurance product, an inference record may be associated with more than one product record. The product records available to the user may be based upon the particular user. For example, if the user is an employee of the service provider managing URES 102, the user may have access to product records for multiple client companies. Alternatively, if the user is an employee of a particular client company, the user may have access only to product records for insurance products offered by the client company.

In one embodiment, one or more scripted texts to be read by personnel may be established. For example, a scripted text may provide an interviewer with the appropriate language for acquiring disclosure data from a proposed insured, for communicating a rating class to the proposed insured, etc.

It is to be understood that the order of the process described is structured for illustrative purposes and is not to be construed as limiting and the process may be accomplished in a different order. For example, a product record may be established prior to the creation of product rules and product rules may then be generated and assigned to an inference record for the product record.

### Application Data Evaluation

FIG. 4 depicts a flowchart of a process of evaluating application data to determine a rating class for a proposed insured according to an exemplary embodiment. URES 102 may access product rule data included in a product record for an insurance product for which a proposed insured is to be considered (step 402). The accessed product rule data may indicate the rating class associated with the relevant product, the initial rating class for a proposed insured, etc. URES 102 may set the initial class rating for the proposed insured (step 404). In one embodiment, the initial rating class is the optimum rating for the insurance product. For example, the proposed insured may be initially assigned the Preferred rating class. Per the product rule data for the insurance product, URES 102 may receive disclosure data (step 406) and third-party source data (step 408) associated with the proposed insured. In one embodiment, the application data employed for the evaluation may include only disclosure data or third-party source data. As mentioned, URES 102 may receive such data via application data management system 128 and/or directly from one or more other components of application data evaluation network 100. The evaluation may be initiated at one or more times or occasions. In one scenario, the application data evaluation may occur at a point of transaction and/or may be combined with an interview process (e.g., conducted in face, over the telephone, and/or via a computer interface) and/or conducted via an electronic application (e.g., software installed on a computer or mobile device, via a Web site interface, etc.). In another scenario, application data may be evaluated at the beginning of the proposed insured's application process, as may be required for fully underwritten products.

URES 102 may evaluate the disclosure data and/or third-party source data in regard to a product rule for the insurance product (step 410). URES 102 may determine if a product rule criterion has been met (step 412). If so URES 102 may lower the rating class associated with the proposed insured (step 414). For example, a product rule criterion may pertain to whether the proposed insured has taken a particular pharmaceutical. If so, the proposed insured's rating class may be lowered, such as, for example, from Preferred to Standard. Depending upon one or more stipulations of the product rule, the proposed insured's rating class may be lowered more than one category. In one embodiment, a proposed insured's rating class may never be raised once it is lowered unless the process is overridden by a system administrator.

If the product rule criterion has not been met or after the rating class has been lowered due to the product rule criterion, URES 102 may determine if the evaluation of the application data is complete (step 416). For example, if URES 102 has evaluated the application data in terms of all product rules for the insurance product or if the proposed insured has been assigned the lowest possible rating class (e.g., Declined), the evaluation may be complete. If the evaluation is not complete, URES may continue to evaluate the application data in regards to the product rule data (step 410).

Application data may be received for evaluation by URES 102 in one or more fashions. In one embodiment, URES 102 may obtain a portion or all application data prior to determining and/or communicating a rating class. In another embodiment, disclosure data and/or third-party source data is received and/or evaluated one data element at a time. For example, while conducting an interview with a proposed insured, an interviewer may input each element of disclosure data via interviewer mechanism 118 as it is received. In another example, an insurance agent or the proposed insured may provide application data one data element at a time via application mechanism 106. URES 102 may evaluate each data element as it is received, adjusting the rating class as necessary. This may continue until a final rating class has been determined. In one scenario, URES 102 may communicate data regarding the proposed insured's current rating class to interviewer mechanism 118 and/or application mechanism 106 as the evaluation transpires so that the appropriate party may be aware of the rating class at any time during the evaluation.

Once the evaluation of the application data is complete, URES 102 may communicate the final rating class (step 418). Additionally, URES 102 may communicate data regarding product rule activity, including details regarding which product rule criteria were met and in what regard. In one embodiment, URES 102 may also provide scripted text to be read by personnel when communicating the rating class to the proposed insured and/or the insurance agent.

By evaluating application data in terms of what product criteria require the lowering of a rating class, URES 102 may assign a rating class based upon the proposed insured characteristics, as opposed to a rating class based upon values assigned to product criteria. A product rule criterion may indicate a risk related to the proposed insured which is unaffected by other characteristics. As such, the risk may not be counterbalanced by another characteristic of the proposed insured. This enables the assignment of a rating class based upon individual elements of the received application data rather than based upon a calculated score that, while meant to be reflective of the proposed insured's risk, in actuality provides an assessment detached from the details of the application data.

It is to be understood that the initial rating class being an optimum (e.g., highest, preferred, etc.) rating class and being lowered per met product criteria is but one embodiment and this is not to be construed as limiting. The initial rating class may be any rating class appropriate per implementation. For example, in one embodiment, the initial rating class may be a worst (e.g., lowest, declined, etc.) rating class and may be raised per product criteria met. Additionally, although throughout the disclosure the subject matter is discussed as: if a product criteria is met, the initial rating class is adjusted; this is not to be construed as limiting and could also be if a product criteria is not met, the initial rating class is adjusted.

Systems, methods, apparatuses, and computer-readable medium for enabling the evaluation of data for insurance underwriting processing have been illustrated. It will be appreciated by those skilled in the art that other variations of the disclosed subject matter will be possible without departing from the scope of the disclosure.

These and other aspects of the present disclosed subject matter will become apparent to those skilled in the art by a review of the preceding detailed description. Although a number of salient features of the disclosed subject matter have been described above, the disclosed subject matter is capable of other embodiments and of being practiced and carried out in various ways that would be apparent to one of ordinary skill in the art after reading the disclosure. Therefore, the description should not be considered to be exclusive of these other embodiments. Also, it is to be understood that the phraseology and terminology employed herein are for the purposes of description and should not be regarded as limiting.

What is claimed is:

1. An underwriting rules engine computer comprising a processor and memory storing executable instructions that, in response to execution by the processor, cause the underwriting rules engine computer to:
access product rule data for an insurance product, wherein the product rule data includes one or more criteria that negatively affect an insurance application rating class associated with an individual seeking to obtain insurance;
set the insurance application rating class associated with the individual;
receive application data regarding the individual, wherein the application data is indicative of one or more of the individual's qualifications to obtain the insurance product;
evaluate the application data per a criterion included in the product rule data, wherein:
if the criterion is not met, the insurance application rating class associated with the individual is not adjusted, and
if the criterion is met, the insurance application rating class associated with the individual is adjusted;
determine whether all the criteria included in the product rule data have been evaluated, wherein:
if all the criteria included in the product rule data have not been evaluated, the application data is evaluated per another criterion included in the product rule data, and
if all the criteria included in the product rule data have been evaluated, the insurance application rating class is determined to be a final rating class associated with the individual.

2. The underwriting rules engine computer of claim 1, wherein the executable instructions further cause the underwriting rules engine computer to receive application data provided by one or more of the following: the individual seeking to obtain insurance and one or more third-party application data sources.

3. The underwriting rules engine computer of claim 2, wherein a third-party application data source is one or more of the following: an identity verification system, a financial institution system, a third-party underwriting system, a pharmaceutical data system, a Medical Information Bureau system, a medical record system, and a motor vehicle record data system.

4. The underwriting rules engine computer of claim 1, wherein the executable instructions further cause the underwriting rules engine computer to receive product rule data for the insurance product.

5. The underwriting rules engine computer of claim 1, wherein the executable instructions further cause the underwriting rules engine computer to configure the one or more criteria that negatively affect the insurance application rating class associated with the individual seeking to obtain insurance.

6. The underwriting rules engine computer of claim 1, wherein the executable instructions further cause the underwriting rules engine computer to communicate the final rating class associated with the individual to an application data management system.

7. The underwriting rules engine computer of claim 1, wherein the executable instructions further cause the underwriting rules engine computer to store one or more of the following: product rule data, application data received from an individual, and application data received from a third-party application data source.

8. The underwriting rules engine computer of claim 7, wherein the product rule data includes data for more than one insurance product.

9. A method to generate an insurance application rating class, the method comprising:
accessing, by an underwriting rules engine computer, product rule data for an insurance product, wherein the product rule data includes one or more criteria that negatively affect an insurance application rating class associated with an individual seeking to obtain insurance;
setting the insurance application rating class associated with the individual;
receiving application data regarding the individual, wherein the application data is indicative of one or more of the individual's qualifications to obtain the insurance product;
evaluating the application data per a criterion included in the product rule data, wherein:
if the criterion is not met, not adjusting the insurance application rating class associated with the individual, and
if the criterion is met, adjusting the insurance application rating class associated with the individual;
determining whether all the criteria included in the product rule data have been evaluated, wherein:
if all the criteria included in the product rule data have not been evaluated, evaluating the application data per another criterion included in the product rule data, and
if all the criteria included in the product rule data have been satisfied, determining that the insurance application rating class is a final rating class associated with the individual.

10. The method of claim 9, wherein receiving application data regarding the individual comprises receiving the application data from one or more of the following: the individual seeking to obtain insurance and one or more third-party application data sources.

11. The method of claim 9, further comprising receiving product rule data for the insurance product.

12. The method of claim 9, further comprising configuring the one or more criteria that negatively affect an insurance application rating class associated with an individual seeking to obtain insurance.

13. The method of claim 9, further comprising communicating the final rating class associated with the individual to an application data management underwriting rules engine computer.

14. The method of claim 9, further comprising storing one or more of the following: product rule data, application data received from an individual, and application data received from a third-party application data source.

15. A non-transitory computer-readable medium storing program code that cause an underwriting rules engine computer to:
access product rule data for an insurance product, wherein the product rule data includes one or more criteria that negatively affect an insurance application rating class associated with an individual seeking to obtain insurance;
set the insurance application rating class associated with the individual, wherein the insurance application rating class is initially an optimum rating;
receive application data regarding the individual, wherein the application data is indicative of one or more of the individual's qualifications to obtain the insurance product;
evaluate the application data per a criterion included in the product rule data, wherein:
if the criterion is not met, the insurance application rating class associated with the individual is not adjusted, and
if the criterion is met, the insurance application rating class associated with the individual is adjusted;
determine whether all the criteria included in the product rule data have been evaluated, wherein:
if all the criteria included in the product rule data have not been evaluated, the application data is evaluated per another criterion included in the product rule data, and
if all the criteria included in the product rule data have been evaluated, the insurance application rating class is determined to be a final rating class associated with the individual.

16. The non-transitory computer-readable medium of claim 15, wherein the program code further causes the underwriting rules engine computer to receive application data provided by one or more of the following: the individual seeking to obtain insurance and one or more third-party application data sources.

17. The non-transitory computer-readable medium of claim 15, wherein the program code further causes the underwriting rules engine computer to receive product rule data for the insurance product.

18. The non-transitory computer-readable medium of claim 15, wherein the program code further causes the underwriting rules engine computer to configure the one or more criteria that negatively affect an insurance application rating class associated with an individual seeking to obtain insurance.

19. The non-transitory computer-readable medium of claim 15, wherein the program code further cause the underwriting rules engine computer to communicate the final rating class associated with the individual to an application data management underwriting rules engine computer.

20. The non-transitory computer-readable medium of claim 15, wherein the program code further cause the underwriting rules engine computer to store one or more of the following: product rule data, application data obtained from an individual, and application data obtained from a third-party application data source.
